(19) United States
(12) Patent Application Publication
(10) Pub. No.: US 2021/0170913 A1
(43) Pub. Date: Jun. 10, 2021

(54) BRACKET TO SUPPORT COVERING OF ELECTRIFIED CONTACT RAIL IN RAILWAY SYSTEMS

(71) Applicant: Pandrol Limited, Surrey (GB)

(72) Inventor: Anthony Fazio, Havertown, PA (US)

(21) Appl. No.: 17/247,412

(22) Filed: Dec. 10, 2020

Related U.S. Application Data
(60) Provisional application No. 62/946,242, filed on Dec. 10, 2019.

(51) Int. Cl. B60M 1/30

(52) U.S. Cl. CPC B60M 1/30

(57) ABSTRACT

An insulated cover board support bracket that includes a self-contained resilient fastener that engages and secures the bracket and in turn cover board to an electrical collector rail of a railway system.

### CROSS-REFERENCE TO RELATED APPLICATION

This patent application claims benefit to U.S. Provisional Patent Application No. 62/946,242, filed Dec. 10, 2019, which is hereby incorporated by reference in its entirety as part of the present disclosure.

### FIELD OF THE INVENTION

The present invention related generally to a railway system that includes an electrified collector rail for traction (propulsion) power and more specifically to a protective support bracket that includes a resilient fastener extending therefrom and/or fixed thereto which is configured to aid in securing the bracket to a conductor rail and on which a cover board can be mounted.

### BACKGROUND OF THE INVENTION

In some electrified railway systems, a third or conductor rail is used to provide electricity to railway vehicles. A collector shoe is mounted to the rail vehicle, which contacts the surface of the conductor rail to provide the railway vehicle with electricity. Many electrified railway systems include an insulative cover that extends above the conductor rail. Such practice requires the cover to be supported above the contact rail without interference of electrical contact surface.

Many known systems to arrange a cover above the conductor rail require fasteners (e.g., screw and/or bolt) to be used to installation and secure a cover bracket above a conduct rail. U.S. Pat. No. 4,318,462, for example, is directed to a bracket configured to support a conductor rail cover that requires a bolt to connect the bracket to the connector rail. other patents directed to brackets that support cover boards only include U.S. Pat. No. 10,596,921 and U.S. Design Pat. No. D816,548

However, the use of fasteners, such as bolts, to secure a cover above a conductor rail adds time to the installation of the cover and can be subject to over or under torqueing during installation, potentially causing a bracket that is used to space the cover from the rail to become loose or break. Fasteners can also corrode and seize overtime and, if they become corroded cannot be retightened, if necessary, and/or may be difficult to untighten, if needed, to remove the cover from the cover from the bracket and as a result must be removed by mechanical and/or chemical means (e.g., cut off).

### SUMMARY OF THE INVENTION

The present disclosure is generally directed to an insulated cover board support bracket that includes a self-contained resilient fastener that engages and secures the bracket and, in turn, cover board to an electrical collector rail of a railway system. More specifically, the resilient fastener engages the flanges of the conductor rail. Tension on the resilient fastener transfers force between the bottom of the flanges of a conductor rail and the insulated support bracket. The resilient fastener can be integral to the bracket and/or secured to the bracket, for example, by a press-fit, rivets, bolts, screws, casting, an adhesive, a combination thereof or the like.

The cover board support bracket of the present disclosure improves the covering support structure by reducing the number of parts required to install the bracket (e.g., loose brackets and hardware) ensuring a constant force is applied by the resilient fastener(s), improves the efficiency of installation and/or removal of a cover board support bracket, removes possible human error during installation such as over or under torqueing a fastener associated with a bracket and the bracket improves safety during installation by reducing the need for tools that may be metallic.

In an embodiment, the present disclosure is directed to a cover board bracket that comprises a body that includes a resilient fastener that extends therefrom to secure the body to a rail of a railway system. The body can have a first leg that extends in a first direction, a second leg that is contiguous at a first end thereof from a second end of the first leg and a third leg that is contiguous at a first end thereof from a second end of the second leg such that the body is substantially c-shaped. The resilient fastener can be formed integral with and fixed to an exterior surface of the third leg. In an embodiment, the resilient fastener extends at an angle from the second leg towards the third leg.

The third leg can include an inner surface that defines a base that extends in a first direction to an outer periphery of the third leg in a second direction to a recess formed by a projection that extends from the second leg to an interior of the bracket, a portion of the second leg and the base.

Alternatively, the third leg can include a first inner surface that defines a base that is delimited at a first end thereof by a stop and at a second end by a flange that includes a first portion that extends from a second end of the third leg, beyond the base and toward the first leg and a second portion that is spaced from the base toward the first leg and extends from a second end of the first portion of the flange toward the second leg to form a recess between the base and the second portion.

The third leg can include recess that is defined by a first sidewall, a second sidewall and a base that extends between the sidewalls.

The resilient fastener can include a first fastener that is rotatably fixed to the first sidewall and a second fastener that is rotatably fixed to the second sidewall.

In another embodiment, the present invention is directed to a method of fixing a cover board support bracket to a conductor rail where the method comprises the steps of providing a body that includes a resilient fastener that extends therefrom; arranging the bracket around the base of a rail; securing a first flange of the rail to the bracket; and rotating the bracket such that the resilient fastener secures a second flange of the rail. Thus, the bracket engages the rail only by an upward force. As a result, the installation and removal of the bracket is safer and easier.

### BRIEF DESCRIPTION OF THE DRAWINGS

FIG. 1 is a cross-sectional view of a cover board support bracket according to an embodiment of the present disclosure;

FIG. 2 is a side view of the bracket of FIG. 1 according to an embodiment of the present disclosure;

FIGS. 3-6 are various views of another cover board support bracket according to an embodiment of the present disclosure; and

FIG. 7 is a perspective view of yet another cover board support bracket according to an embodiment of the present disclosure.

### DETAILED DESCRIPTION OF EMBODIMENTS OF THE PRESENT DISCLOSURE

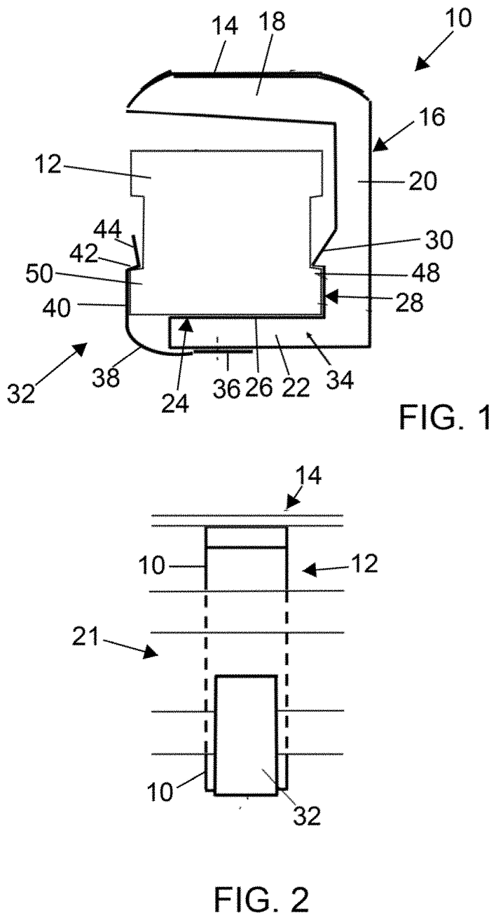

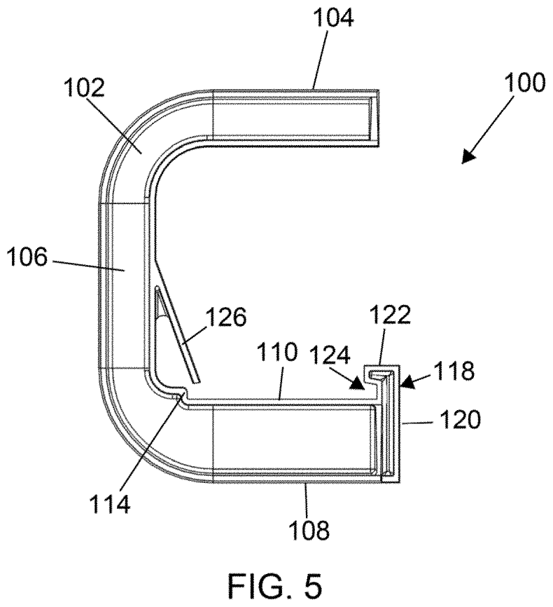

With reference now to the drawings and in particular FIGS. 1-7, embodiments of cover board support brackets of the present disclosure, which are generally designated by reference numerals 10, 100, 200, will be described.

FIGS. 1 and 2 depict an embodiment of an insulated cover board support bracket 10 that is resiliently fastened to a rail 12 (conductor rail) of a railway system in which electricity is collected from the top of the conductor rail 12. A cover board 14 is fixed on a top surface of the bracket 10 in order to protect the top surface of the conductor rail 12. The cover board 14 must be arranged in such a way so that the railway vehicle collector shoe (not shown) can collect electricity from the conductor rail 12 surface.

The bracket 10 includes a body 16 that has a first leg 18 that extends in a first direction, a second leg 20 that is contiguous at a first end thereof from a second end of the first leg 18 and a third leg 22 that is contiguous at a first end thereof from a second end of the second leg 20. As can be seen in FIG. 1, the legs 18, 20, 22 of the body 16 together substantially form a C-shape.

The third leg 22 includes a first inner surface 24 that defines a base 26 that extends in a first direction to an outer periphery of the third leg 22 in a second direction to a recess 28 formed by a projection 30 that extends from the second leg 20 to an interior of the bracket 10, a portion of the second leg 20 and the base 26.

A resilient fastener 32 is integral with or fixed to an exterior surface 34 of the third leg 22, for example, by press-fit, fasteners (e.g., screws, rivets, bolts) and/or an adhesive. The fastener 32 includes a first portion 36 that is substantially linear, a second portion 38, which is curved and extends contiguous at a first end thereof from a second end of the first portion 36, a third portion 40 that extends substantially linearly and contiguous at a first end thereof from a second end of the second portion 38, a fourth portion 42 that extends substantially linearly at an angle a from a second end of the third portion 40 and a fifth portion 44 that extends substantially linearly at an angle a from a second end of the forth portion 42.

The bracket 10 is configured to be fixed to the rail 12 with a portion of a base 46 of the rail 12 seated on the base 26 of the bracket 10, a first flange 48 of the rail 12 arranged and secured within the recess 28 of the bracket 10 and the resilient flange 32 exerting an upward force with respect to the rail 12 to extend around and secure a second flange 50 of the rail 10 in a fixed position. Once the bracket 10 is fixed to the rail 12, it is slid along the rail 10 to align the holes in the bracket (not shown) with holes in a cover board and lock it in place. To release the bracket 10, a tool such as a screw driver or special insulated tool, can be used. The resilient fastener 32 both eliminates the need for use of bolts, spikes, screws, adhesives, etc. to secure the bracket 10 to the rail 12 and exerts a continuous force between the insulated bracket 10 and the electrified conductor rail 12.

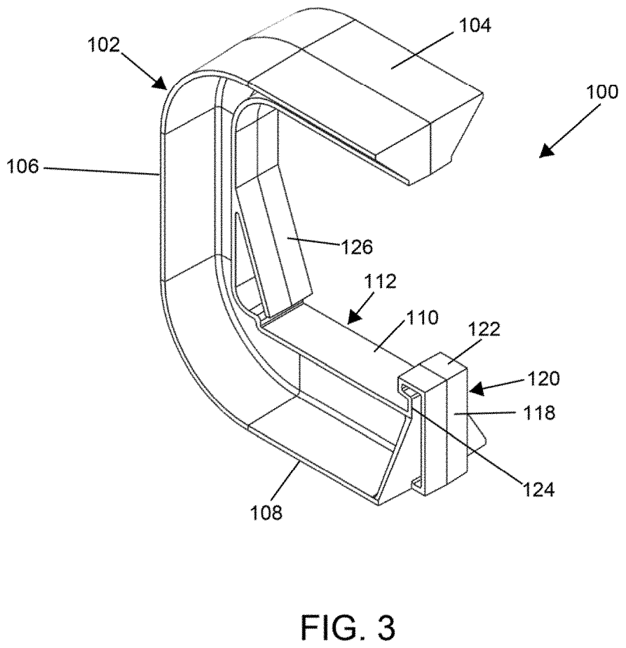

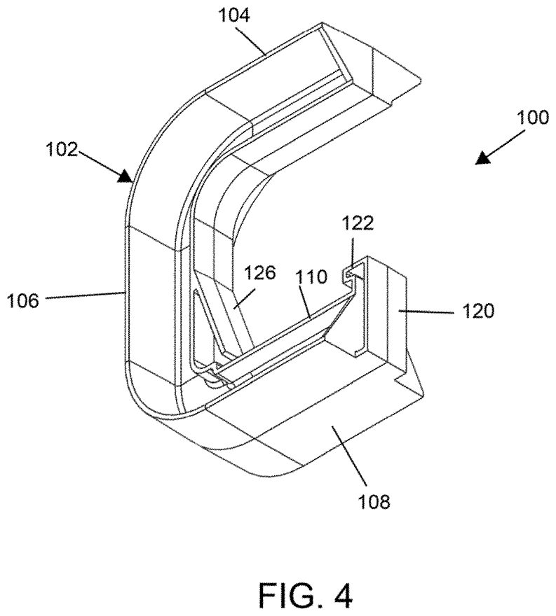

FIGS. 3-6 illustrates various views of another embodiment of a cover board bracket 100 that includes a body 102 that has a first leg 104 that extends in a first direction, a second leg 106 that is contiguous at a first end thereof from a second end of the first leg 104 and a third leg 108 that is contiguous at a first end thereof from a second end of the second leg 106. The legs 104, 106, 108 define a rib that extends continuously in substantially a C-shape. A cover board (not shown) can be fastened to an external portion of the first leg 104 of the bracket 100.

The third leg 108 includes a first inner surface 110 that defines a base 112 that is delimited at a first end thereof by a stop 114 and at a second end by a flange 118 that includes a first portion 120 that extends from a second end of the third leg 108, beyond the base 112 and toward the first leg 104 and a second portion 122 that is spaced from the base 112 toward the first leg 104 and extends from a second end of the first portion 120 of the flange 118 toward the second leg 106 to form a recess 124 between the base 112 and the second portion 120. A resilient projection 126 extends at an angle from the second leg 106 towards the third leg 108.

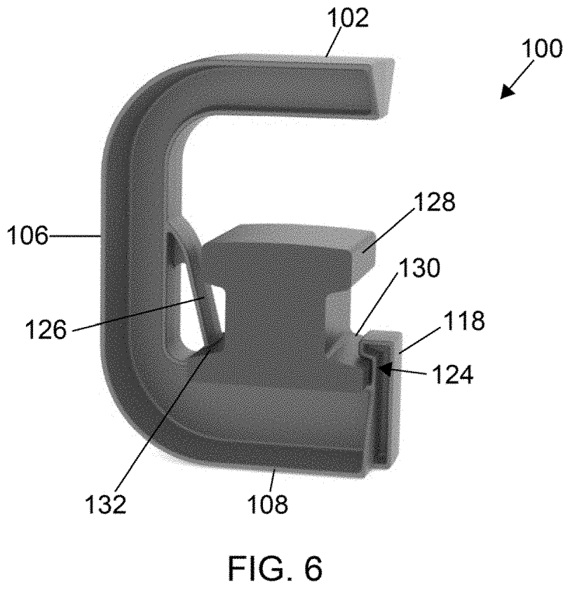

In use, the bracket 100 is placed beneath a lower portion of a rail 128 (see FIG. 6) and rotated in a first direction upwardly such that a first flange 130 of the rail 128 is arranged and secured within the recess 124 formed between the second portion 122 of the flange 120 and the base 112. The bracket 100 is then rotated in a second direction, depressing the resilient elastically deformable projection 126 to allow a second flange 132 of the rail 128 is seated on the base 112 and in contact with the stop 114. Once the second flange 132 of the rail clears the projection 126 and is seated on the base 112, the projection 126 returns to an initial state to contact the second flange 132 and aid, along with the flange 118 in ensuring the bracket 100 remains secured to the rail 128. Once the bracket 100 is fixed to the rail 128, it is slid along the rail 128 to align the holes in the bracket (not shown) with holes in a cover board and lock it in place. To release the bracket 100 to slide and align the bracket 100 with the cover board, a tool such as a screw driver or special insulated tool, can be used.

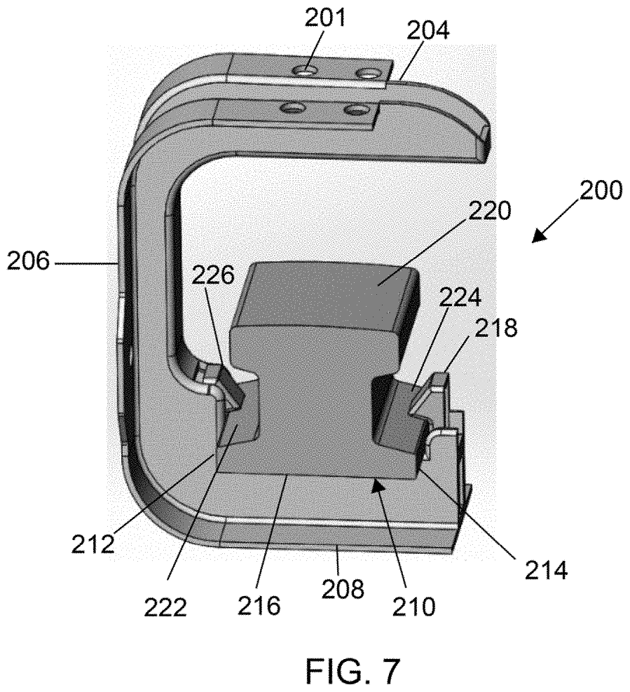

FIG. 7 illustrates yet another embodiment of a cover board bracket 200 that includes a body 202 that has a first leg 204 that extends in a first direction, a second leg 206 that is contiguous at a first end thereof from a second end of the first leg 204 and a third leg 208 that is contiguous at a first end thereof from a second end of the second leg 206. The legs 204, 206, 208 define a rib that extends continuously in substantially a C-shape. A cover board (not shown) can be fastened to an external portion of the first leg 204 of the bracket 200.

The third leg 208 includes recess 210 that includes a first sidewall 212, a second sidewall 214 and a base 216 that extends between the sidewalls 212, 214. A first rotatable fastener 216 is fixed to and/or within the first sidewall 212 and a second rotatable fastener 218 is fixed to and/or within the second sidewall 214.

In use, the bracket 200 is placed beneath a lower portion of a rail 220 and rotated such that a first flange 222 of the rail 220 is arranged and secured between the first fastener 216 and the base 210 and then the second flange 224 of the rail 220 contacts the base 210 and the second fastener 218 is then rotated to contact an upper region of the second flange 224 of the rail 220 and secure the second flange 224 to the bracket 200. That is, in combination the first fastener 216 and the second fastener 218 secure the bracket 200 to the rail 220 without the need for fasteners (e.g., bolts, screws, spikes) that are independent of the bracket 200 and/or the use of an adhesive; the bracket 200 is a self-contained device that does not require additional components. Once the bracket 200 is fixed to the rail 220, it is slid along the rail 220 to align the holes in the bracket 201 with holes in a cover board and lock it in place. To release the bracket 200, a tool such as a screw driver or special insulated tool, can be used.

Although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. It is to be understood that the phraseology or terminology employed herein is for the purpose of description and not of limitation. In addition, while several variations of the embodiments of the invention have been shown and described in detail, other modifications, which are within the scope of this invention, including, but not limited to, the substitutions of equivalent features, materials, or parts, will be readily apparent to those of skill in the art based upon this disclosure without departing from the spirit and scope of the invention.

What is claimed is:

1. A cover board support bracket, comprising:
a body that includes a resilient fastener that at least one of extends therefrom and is fixed thereto to secure the body to a rail of a railway system.

2. The cover board support bracket of claim 1, wherein the body includes a first leg that extends in a first direction, a second leg that is contiguous at a first end thereof from a second end of the first leg and a third leg that is contiguous at a first end thereof from a second end of the second leg.

3. The cover board support bracket of claim 1, wherein the body is substantially c-shaped.

4. The cover board support bracket of claim 2, wherein the third leg includes an inner surface that defines a base that extends in a first direction to an outer periphery of the third leg in a second direction to a recess formed by a projection that extends from the second leg to an interior of the bracket, a portion of the second leg and the base.

5. The cover board support bracket of claim 1, wherein the resilient fastener is one of formed integral with and fixed to an exterior surface of the third leg.

6. The cover board support bracket of claim 2, wherein the third leg includes a first inner surface that defines a base that is delimited at a first end thereof by a stop and at a second end by a flange that includes a first portion that extends from a second end of the third leg, beyond the base and toward the first leg and a second portion that is spaced from the base toward the first leg and extends from a second end of the first portion of the flange toward the second leg to form a recess between the base and the second portion.

7. The cover board support bracket of claim 2, wherein the resilient fastener extends at an angle from the second leg towards the third leg.

8. The cover board bracket of claim 2, wherein the third leg includes a recess that is defined by a first sidewall, a second sidewall and a base that extends between the sidewalls.

9. The cover board support bracket of claim 2, wherein the resilient fastener includes a first fastener that is rotatably fixed to the first sidewall and a second fastener that is rotatably fixed to the second sidewall.

10. A method of fixing a cover board support bracket to a conductor rail, the method comprising the steps of:
providing a body that includes a resilient fastener that at least one of extends therefrom and is fixed thereto;
arranging the bracket around the base of a rail;
securing a first flange of the rail to the bracket; and
rotating the bracket such that the resilient fastener secures a second flange of the rail.
